(19) United States
(12) Patent Application Publication
(10) Pub. No.: US 2026/0213623 A1
(43) Pub. Date: Jul. 23, 2026

(54) VARIABLE SHUNT PHASER WITH PRESSURE RELIEF MECHANISM

(71) Applicant: GM Global Technology Operations LLC, Detroit, MI (US)

(72) Inventors: Rolando Huerta Ortiz, Grandville, MI (US); Craig S. Ross, Ypsilanti, MI (US)

(21) Appl. No.: 19/035,220

(22) Filed: Jan. 23, 2025

(51) Int. Cl. H02K 11/028; B60L 15/20; H01H 9/00

(52) U.S. Cl. CPC H02K 11/028; B60L 15/2045; H01H 9/0044; B60L 2220/50

(57) ABSTRACT

A variable shunt phaser includes a shell that rotates with a rotor shaft. The shell includes a housing, a gear plate, a back plate coupled to form an enclosed space. A rotation of the shell creates a pressure differential between an outer diameter of the shell and an inner diameter of the shell. An inner rotor within the enclosed space rotates with respect to the housing. A relief orifice is located in the back plate at the outer diameter. A blade is coupled to an exterior section the inner rotor, is external to the shell, and is rotatable with respect to the back plate. An escape hole is in the blade. Rotation of the inner rotor with respect to the housing moves the escape hole into alignment with the relief orifice to open the relief orifice, thereby reducing the pressure differential within the enclosed space.

The subject disclosure relates to an electric motor of an electric vehicle, and in particular to a variable shunt phaser used in the electric motor and a method of relieving a pressure imbalance within the variable shunt phaser that is induced at high motor speeds by a centrifugal pressure effect.

An electric vehicle includes an electric motor having a rotor and stator. The rotor generates rotor fields and the stator generates stator fields. At high motor speeds, a back electromotive force occurs due to interaction of the rotor fields and the stator fields. A variable shunt phaser (VSP) is used to vary a phase relation between the rotor and the stator to reduce this back electromotive force. The VSP is connected to the rotor. The VSP includes a housing and an inner rotor that is configured to be rotating within the housing. Increasing a pressure within a chamber of the VSP changes a relative angular position of the inner rotor to the housing. Recent advances in electric motors allow rotational speeds of the motor and VSP that can exceed 20,000 rpm. At rotation rates above a certain threshold (generally about 6000 rpm), a significant pressure differential occurs within the VSP. This pressure differential can affect the structural integrity of the VSP and thus operation of the motor. Accordingly, it is desirable to provide a method of reducing the pressure differential within the VSP.

### SUMMARY

In one exemplary embodiment, a variable shunt phaser is disclosed. The variable shunt phaser includes a shell configured to rotate with a rotor shaft of an electric motor of an electric vehicle, the shell including a housing, a gear plate a back plate coupled to form an enclosed space within the shell, wherein a rotation of the shell creates a pressure differential between an outer diameter of the shell and an inner diameter of the shell, an inner rotor disposed within the enclosed space, the inner rotor configured to rotate with respect to the housing, a relief orifice in the back plate at the outer diameter of the shell, a blade coupled to an exterior section the inner rotor, wherein the blade is external to the shell and is rotatable with respect to the back plate, and an escape hole in the blade, wherein rotation of the inner rotor with respect to the housing moves the escape hole into alignment with the relief orifice to open the relief orifice, thereby reducing the pressure differential within the enclosed space.

In addition to one or more of the features described herein, the relief orifice is located at the back plate and the escape hole is at a same radial location as the relief orifice.

In addition to one or more of the features described herein, the blade includes a first seal at a first circumferential side of the escape hole and a second seal at a second circumferential side of the escape hole.

In addition to one or more of the features described herein, the variable shunt phaser further includes a channel that extends radially through the housing and the inner rotor includes a vane that rotates within the shell.

In addition to one or more of the features described herein, the variable shunt phaser further includes a seat and a ball within the channel, the ball biased radially inward against the seat by a spring, wherein the ball moves away from the seat when a pressure within the enclosed space reaches a critical pressure defined by the spring.

In addition to one or more of the features described herein, the variable shunt phaser further includes a lamella valve configured to slide radially along the housing and is biased to a position over the channel, wherein the lamella valve moves radially along the housing when a pressure within the enclosed space reaches a critical pressure.

In addition to one or more of the features described herein, a range of angular rotation for the inner rotor is defined by a circumferential width of an interior chamber in the enclosed space.

In another exemplary embodiment, a motor for an electric vehicle is disclosed. The motor includes a rotor shaft and a variable shunt phaser rotatable with the rotor shaft. The variable shunt phaser includes a shell configured to rotate with the rotor shaft, the shell including a housing, a gear plate, and a back plate coupled to form an enclosed space within the shell, wherein rotation of the shell creates a pressure differential between an outer diameter of the shell and an inner diameter of the shell, an inner rotor disposed within the enclosed space, the inner rotor configured to rotate with respect to the housing, a relief orifice in the back plate at the outer diameter of the shell, a blade coupled to an exterior section of the inner rotor, wherein the blade is external to the shell and is rotatable with respect to the back plate, and an escape hole in the blade, wherein rotation of the inner rotor with respect to the housing moves the escape hole into alignment with the relief orifice to open the relief orifice, thereby reducing the pressure differential within the enclosed space.

In addition to one or more of the features described herein, the relief orifice is located at the back plate and the escape hole is at a same radial location as the relief orifice.

In addition to one or more of the features described herein, the blade includes a first seal at a first circumferential side of the escape hole and a second seal at a second circumferential side of the escape hole.

In addition to one or more of the features described herein, the motor further includes a channel that extends radially through the housing and the inner rotor includes a vane that rotates within the shell.

In addition to one or more of the features described herein, the motor further includes a seat and a ball within the channel, the ball biased radially inward against the seat by a spring, wherein the ball moves away from the seat when a pressure within the enclosed space reaches a critical pressure defined by the spring.

In addition to one or more of the features described herein, the motor further includes a lamella valve configured to slide radially along the housing and is biased to a position over the channel, wherein the lamella valve moves radially along the housing when a pressure within the enclosed space reaches a critical pressure.

In addition to one or more of the features described herein, a range of angular rotation for the inner rotor is defined by a circumferential width of an interior chamber in the enclosed space.

In yet another exemplary embodiment, a power system is disclosed. The power system includes a stator, a rotor, and a variable shunt phaser rotatable with the rotor to control a timing between the stator and the rotor. The variable shunt phaser includes a shell configured to rotate with the rotor, the shell including a housing, a gear plate a back plate coupled to form an enclosed space within the shell, wherein rotation of the shell creates a pressure differential between an outer diameter of the shell and an inner diameter of the shell, an inner rotor disposed within the enclosed space, the inner rotor configured to rotate with respect to the housing, a relief orifice in the back plate at the outer diameter of the shell, a blade coupled to an exterior section the inner rotor, wherein the blade is external to the shell and is rotatable with respect to the back plate, and an escape hole in the blade, wherein rotation of the inner rotor with respect to the housing moves the escape hole into alignment with the relief orifice to open the relief orifice, thereby reducing the pressure differential within the enclosed space.

In addition to one or more of the features described herein, the relief orifice is located at the back plate and the escape hole is at a same radial location as the relief orifice.

In addition to one or more of the features described herein, the blade includes a first seal at a first circumferential side of the escape hole and a second seal at a second circumferential side of the escape hole.

In addition to one or more of the features described herein, the power system further includes a channel that extends radially through the housing and the inner rotor includes a vane that rotates within the shell.

In addition to one or more of the features described herein, the power system further includes a seat and a ball within the channel, the ball biased radially inward against the seat by a spring, wherein the ball moves away from the seat when a pressure within the enclosed space reaches a critical pressure defined by the spring.

In addition to one or more of the features described herein, the power system further includes a lamella valve configured to slide radially along the housing and is biased to a position over the channel, wherein the lamella valve moves radially along the housing when a pressure within the enclosed space reaches a critical pressure.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an embodiment of a vehicle, in accordance with an exemplary embodiment;

FIG. 2 is a partial disassembled view of a section of an electric motor of the vehicle;

FIG. 3 is a perspective view showing an exterior of a variable shunt phaser (VSP);

FIG. 4 shows a perspective view of an interior of the VSP;

FIG. 5 shows a first side of a rotating valve of the VSP, in an embodiment;

FIG. 6 shows a second side of the rotating valve, in an embodiment;

FIG. 7 shows a view of the exterior of the VSP, with the rotating valve in a partially rotated position;

FIG. 8 shows a view of the interior of the VSP at a maximum articulation angle;

FIG. 9 a view of the interior of the VSP in an embodiment;

FIG. 10 is a view along an axial direction of a section of the housing for the embodiment of FIG. 9 in one configuration;

FIG. 11 is a view along an axial direction of the section of the VSP for the embodiment of FIG. 9 in another configuration;

FIG. 12 is a view along the axial direction of the section of the VSP for the embodiment of FIG. 9 in yet another configuration;

FIG. 13 is a view along the axial direction of the section of the VSP for the embodiment of FIG. 9 in yet another configuration; and

FIG. 14 is a view of the interior of the VSP in another embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

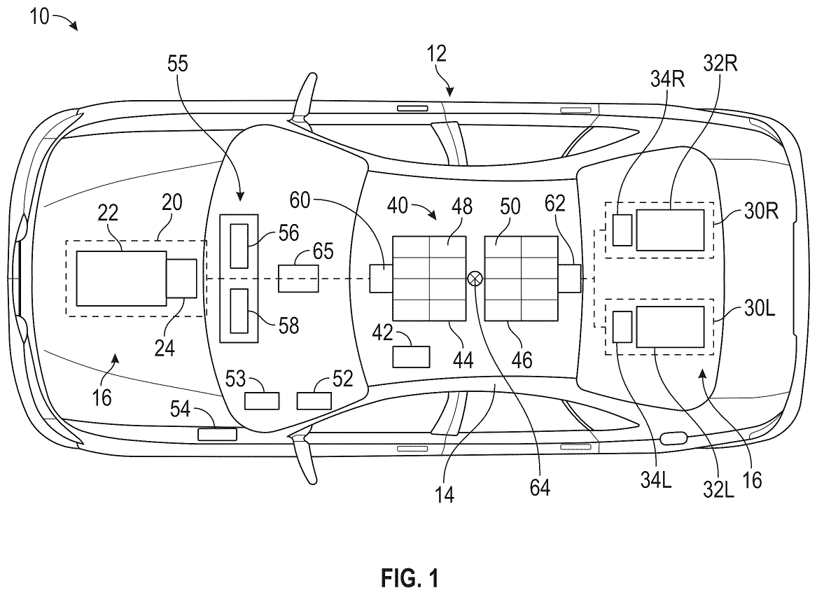

In accordance with an exemplary embodiment, FIG. 1 shows an embodiment of a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. In an alternative embodiment, the vehicle 10 can be an internal combustion engine vehicle, a hybrid vehicle, etc. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes a left rear electric motor 32L and a left rear inverter 34L. A right rear drive unit 30R includes a right rear electric motor 32R and a right rear inverter 34R. The front inverter 24, left rear inverter 34L and right rear inverter 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 the left rear electric motor 32L and the right rear electric motor 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives the front wheels (not shown), and the left rear electric motor 32L and right rear electric motor 32R drive the rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to the battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

In an embodiment, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the front inverter 24, and a second battery pack 46. The first battery pack 44 includes a first plurality of battery modules 48, and the second battery pack 46 includes a second plurality of battery modules 50. Each of the first plurality of battery modules 48 and the second plurality of battery modules 50 includes a number of individual cells (not shown).

Each of the front electric motor 22 and the left rear electric motor 32L and right rear electric motor 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the first battery pack 44 and second battery pack 46, and selectively connecting the first battery pack 44 and second battery pack 46 to the front drive unit 20, left rear drive unit 30L and right rear drive unit 30R. The switching devices may also be operated to selectively connect the first battery pack 44 and the second battery pack 46 to a charging system. The charging system can be used to charge the first battery pack 44 and the second battery pack 46, and/or to supply power from the first battery pack 44 and/or the second battery pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for DC charging (e.g., DC fast charging or DCFC).

In an embodiment, the switching system includes a first switching device 60 that selectively connects to the first battery pack 44 to the front inverter 24, left rear inverter 34L and right rear inverter 34R, and a second switching device 62 that selectively connects the second battery pack 46 to the front inverter 24, left rear inverter 34L and right rear inverter 34R. The switching system also includes a third switching device 64 (also referred to as a “battery switching device”) for selectively connecting the first battery pack 44 to the second battery pack 46 in series.

Any of various controllers can be used to control functions of the battery system 40, the switching system and the drive units. A controller includes any suitable processing device or unit, and may use an existing controller such as a drive system controller, an RESS controller, and/or controllers in the drive system. For example, a controller 65 may be included for controlling switching and drive control operations as discussed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

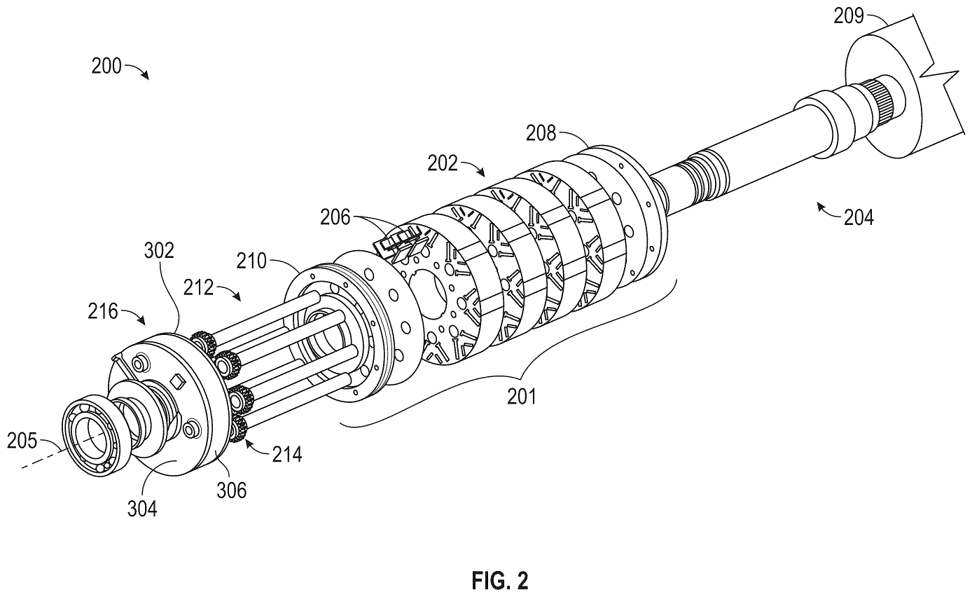

FIG. 2 is a partial disassembled view 200 of a section of an electric motor of the vehicle 10. Rotor 201 includes rotor core laminations 202 disposed on a rotor shaft 204 which extends along a longitudinal axis 205. The rotor core laminations 202 include pockets with magnets 206 disposed in the pockets. The rotor core laminations 202 are constrained axially on the rotor shaft 204 by first end piece 208 and second end piece 210. The rotor 201 is disposed within a housing or stator 209 having stator coils (not shown). The stator coils are timed to generate varying stator magnetic fields when the magnets 206 of the rotor are at a prescribed angular relation (or phase relation) with respect to the stator coils, thereby causing the rotor shaft 204 to rotate. Field shunts 212 are affixed to the rotor core laminations 202 at various circumferential locations about the rotor shaft 204 and extend along the longitudinal axis 205. A variable shunt phaser (VSP 216) includes a sun gear (not shown) on its outer surface. Each field shunt 212 includes a pinion gear 214. Each pinion gear 214 is coupled to the VSP 216 via the sun gear.

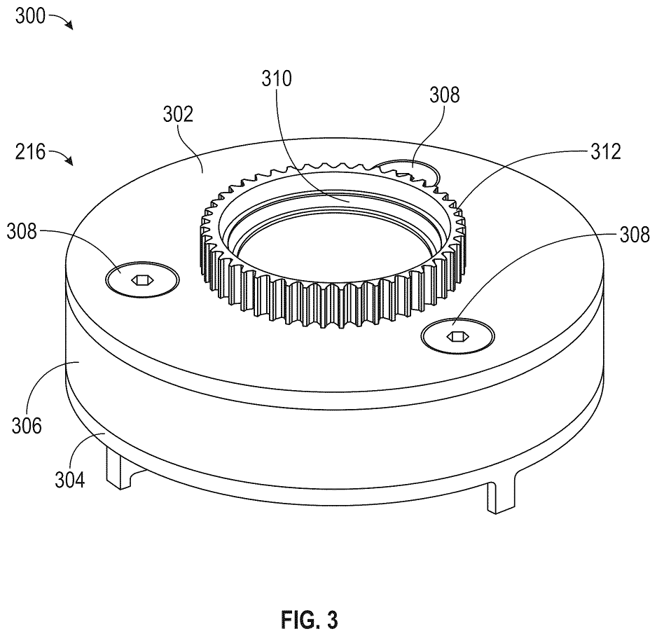

FIG. 3 is a perspective view 300 showing an exterior of the VSP 216. The VSP 216 is a shell that forms an enclosed space. The shell is formed by a gear plate 302, a back plate 304, housing 306 and a collar 310. The gear plate 302 is an annular ring having an outer diameter and an inner diameter. The back plate 304 is similarly an annular ring having an outer diameter that is the same as the outer diameter of the gear plate 302 and an inner diameter that is the same dimension as the inner diameter of the gear plate 302. The housing 306 has a cylindrical outer surface at the outer diameter. The collar 310 is a cylindrical shell at the inner diameter. A set of mounting bolts 308 connect the gear plate 302 to the back plate 304 with the housing 306 and collar 310 separating the gear plate from the back plate to create the enclosed space inside the VSP 216. The VSP 216 is mounted to the rotor shaft 204 via the collar 310 and thereby rotates with the rotor shaft. A sun gear 312 is located at the inner diameter of the gear plate 302 and is static with respect to the gear plate. The sun gear 312 is in contact with the pinion gears 214 (FIG. 2).

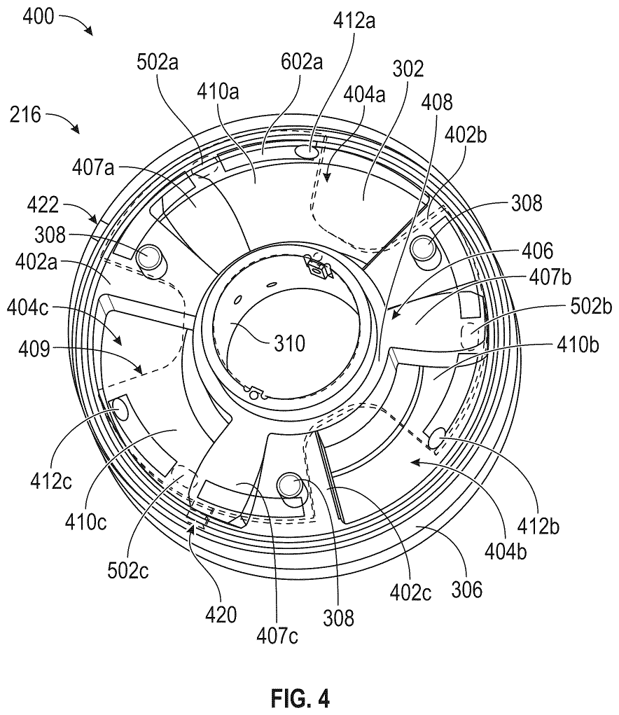

FIG. 4 shows a perspective view 400 of the VSP 216, showing an interior of the VSP. In the perspective view 400, the back plate 304 is toward the front and the gear plate 302 is toward the back. The back plate 304 is not shown so as to reveal the insides of the VSP 216. The housing 306 defines an outer diameter of the VSP 216. Lugs 402a-402c extend radially inward from an inner surface of the housing 306 to define interior chambers 404a-404c within the VSP 216. The mounting bolts 308 pass through the lugs 402a-402c to secure the gear plate 302 to the back plate 304.

An inner rotor 406 of the VSP 216 is rotatable within the VSP 216. The inner rotor 406 includes a hub 408 that is one with the collar 310 and vanes 407a-407c that extend radially outwardly from the hub 408 and into respective interior chambers 404a-404c. The circumferential width of the interior chambers 404a-404c (as defined by the lugs 402a-402c) define a range of angular rotation for the vanes 407a-407c and thus of the inner rotor 406. The hub 408 includes an exterior section that extends through the back plate 304 and outside of the VSP 216. A rotating valve 409 is mounted onto the inner rotor at the exterior section of the collar 310. When mounted, the rotating valve 409 and the inner rotor 406 rotate together. The rotating valve 409 includes blades 410a-410c that extend radially outward from the exterior section of the hub 408. The blades 410a-410c are therefore outside of the VSP 216 but overlap respective interior chambers 404a-404c. The blades 410a-410c act as a valve for equalizing pressure within the VSP 216.

A control system (such as controller 65) can control a hydraulic pressure within the enclosed space to induce the inner rotor 406 to rotate with respect to the housing 306. The hydraulic pressure can be increased in direct proportion to a commanded motor speed. Alternatively, the hydraulic pressure can be changed independently of the motor speed. The hydraulic pressure can be transmitted through a fluid (such as an oil) in the VSP 216.

The back plate 304 includes relief orifices 412a-412c located at or near the outer diameter of the housing 306. The relief orifices 412a-412c are separated angularly equidistant from each other in the circumferential direction, with one relief orifice per interior chamber.

A first tab 420 at an outer edge of a blade (e.g., blade 410c) and moves with the blades. A second tab 422 is located at the outer edge of the back plate 304 of the VSP 216 and is stationary. The first tab 420 and the second tab 422 serve as reading flags for a position sensor of the electrical motor control system. When the VSP 216 is being operated with the inner rotor 406 in a default position, the first tab 420 and the second tab 422 are overlapping or at a predefined angular separation from each other. The control system can determine an angle of rotation of the inner rotor 406 by determining an angular separation between the first tab 420 and the second tab 422. Based on the angle of rotation, the control system can trigger a signal to command the rotation of the field shunts 212, thereby changing the timing of the field shunts 212 and causing a magnetic flux draw, or “leakage” which reduces an occurrence of a back electromotive force (BEMF) at high speeds. This results in improved performance of the motor. The relative rotation of the shunts 212 is related to the angle indicated by the first tab 420 and the second tab 422.

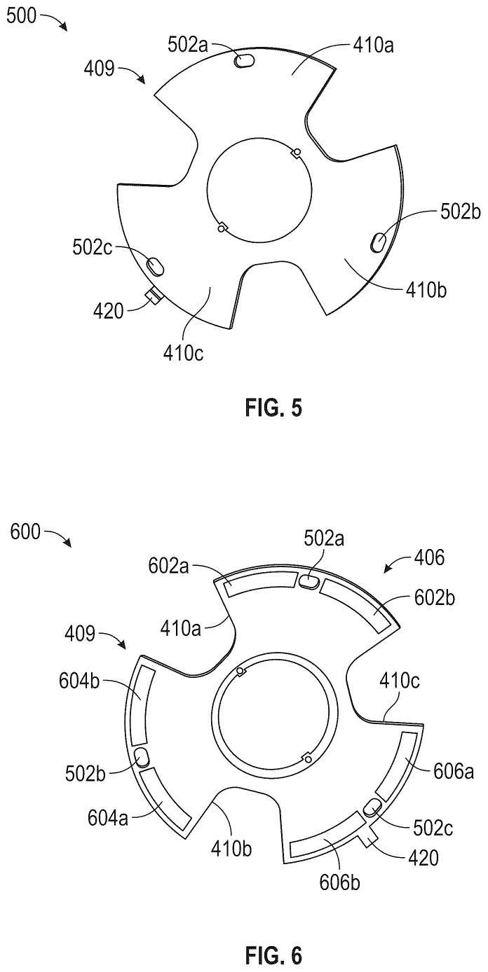

FIG. 5 shows a first side 500 of the rotating valve 409, in an embodiment. Each blade 410a-410c includes an escape hole 502a-502c. Each escape hole 502a-502c is centrally located along the outer edge of its respective blade 410a-410c. When the inner rotor 406 is installed in the VSP 216, the first side 500 is facing away from the VSP 216 and the escape holes 502a-502c are at a same radial distance from the axial center of the VSP 216 as the relief orifices 412a-412c of the back plate 304.

FIG. 6 shows a second side 600 of the rotating valve 409, in an embodiment. When the inner rotor 406 is installed in the VSP 216, the second side 600 faces the gear plate 302. Each blade 410a-410c includes a first seal at one side of its escape hole 502a-502c and a second seal at a second side of the escape hole. The first seal and the second seal are located at the same radial location from the escape hole. Thus, escape hole 502a is surrounded by seal 602a at a first circumferential side and seal 602b at a second circumferential side, escape hole 502b is surrounded by seal 604a at a first circumferential side and seal 604b at a second, circumferential side, and escape hole 502c is surrounded by seal 606a and at a first circumferential side and seal 606b at a second circumferential side. Each seal extends circumferentially from the escape hole to a radial edge of its respective blade.

Returning to FIG. 4, the VSP 216 is shown in a default position. The default position corresponds to normal operation of the motor (such as the front electric motor 22) in which no reduction of the back EMF is required. In the default position, the inner rotor 406 and blades 410a-410c are in a first phase relation with respect to the housing 306, as can be observed by the position of vane 407a. In the default position, the escape hole 502a is unaligned with the relief orifice 412a located in the back plate 304 and is at a counterclockwise location with respect to the relief orifice 412a. Instead, seal 602a is over the relief orifice 412a, thereby sealing off the interior of the VSP 216 from the exterior of the VSP, thus maintaining the pressure in the interior chambers.

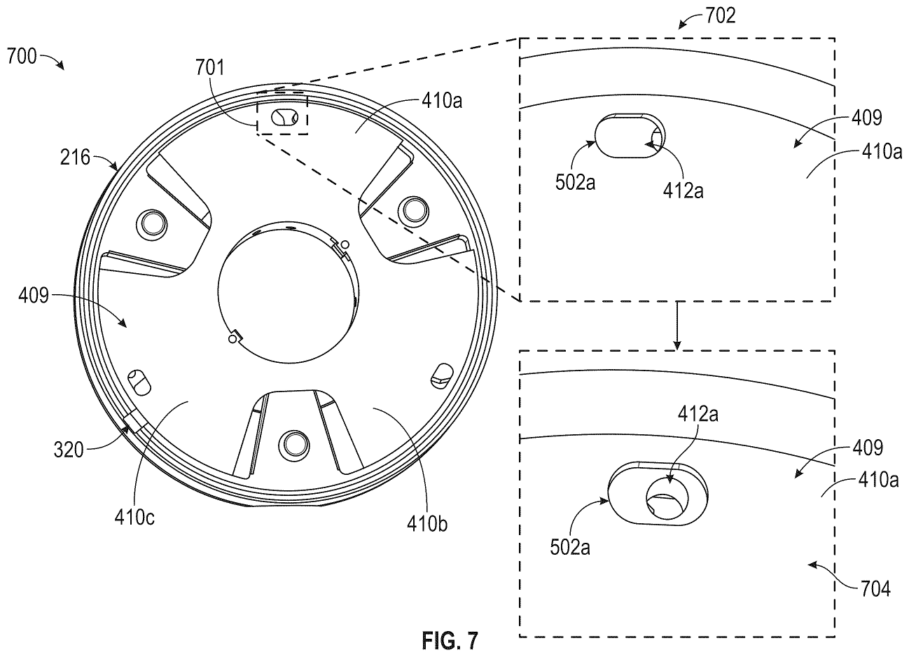

FIG. 7 shows a view 700 of the exterior of the VSP, with the rotating valve 409 in a partially rotated position. The increased rotation speeds of the motor (such as the front electric motor 22) and the VSP 216 create a pressure differential between the inner diameter of the VSP 216 and the outer diameter of the VSP 216. The pressure differential becomes significant at higher speeds, such as greater than 6000 rpm. A commanded pressure signal provided by the control system rotates the rotating valve 409 so that the blades 410a-410c move in a clockwise direction. At a selected relative angle between the inner rotor 406 with rotating valve 409 and the housing, the blades 410a-410c are in a second phase relation with respect to the housing 306. In the second phase relation, the escape hole 502a is in circumferential alignment with the relief orifice 412a.

FIG. 7 includes a first blow-up view 702 and a second blow-up view 704 of the region 701 around the relief orifice 412a. As shown in the first blow-up view 702, the escape hole 502a is at a crack-open position of the relief orifice 412a. As shown in the second blow-up view 704, the escape hole 502a achieves full alignment with the relief orifice 412a. Full alignment occurs when the blades 410a-410c reach a critical angle of rotation, typically around the mid-range of the full rotational range. From the moment the escape hole 502a is at the crack-open position to where it reaches maximum alignment with the relief orifice 412a, the high-pressure imbalance (or pressure differential in the interior chamber 404a is reduced to allow the inner rotor 406 to overcome loads on it due to the pressure differential.

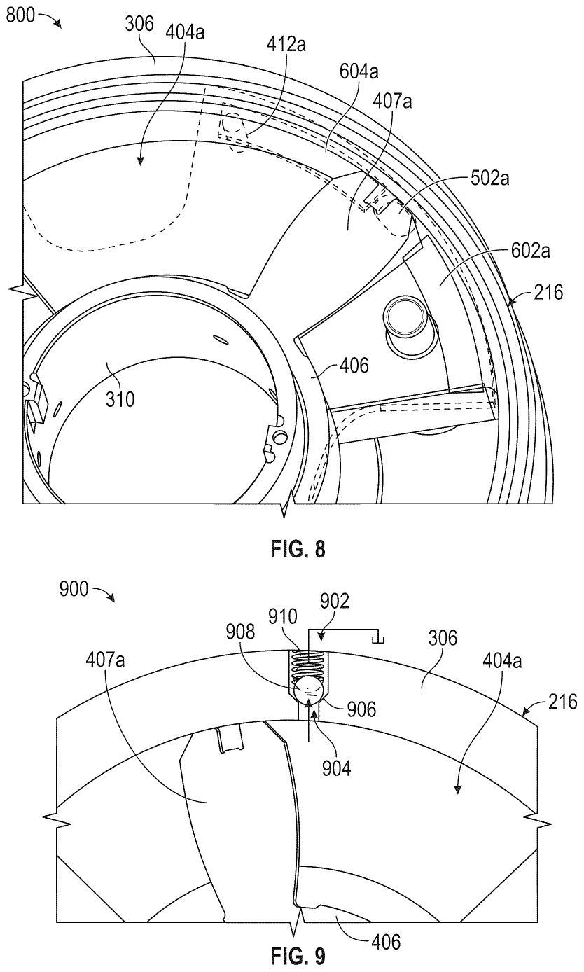

FIG. 8 shows a view 800 of the interior of the VSP 216 at a maximum articulation angle. The blades 410a-410c are in a third phase relation with respect to the housing 306. The escape hole 502a is in a clockwise location with respect to the relief orifice 412a, thus placing the seal 604a over the relief orifice. Once the inner rotor 406 has reached the maximum commanded angle, the relief orifice 412a is sealed and the actuator sustains the required torque to keep the inner rotor 406 in the required position, until a new command triggers the inner rotor 406 to return to its home position as shown in FIG. 4.

FIG. 9 a view 900 of the interior of the VSP 216 in an embodiment. The back plate and the blade are not shown in FIG. 9 for clarity of view. For each interior chamber 404, the VSP 216 includes a check valve 902 located in the wall of the housing 306. The check valve 902 is a ball-spring check valve that includes a channel 904 that extends into the housing 306. The channel 904 includes a seat 906. A ball 908 in the channel 904 is biased radially inward against the seat 906 by a spring 910 or another suitable biasing device.

As a rotation angle of inner rotor 406 and rotating valve 409 (not shown in FIG. 9) increases, the vane 407a moves clockwise. As the vane 407 reaches a selected angle, a relief hole is radially aligned with the channel 904, thereby allowing a pressure within the interior chamber to press against the ball.

The ball 908 moves against the spring 910 when a magnitude of the pressure in the VSP 216 reaches or exceeds a critical pressure needed overcome the biasing force of the spring 910. The critical pressure is defined by the characteristics of the spring 910. The spring 910 can allow the ball 908 to move away from the seat 906 when the critical pressure has been reached, even if the relief orifice 412a of the back plate 304 and the escape hole 502a of the blade 410a are not fully aligned.

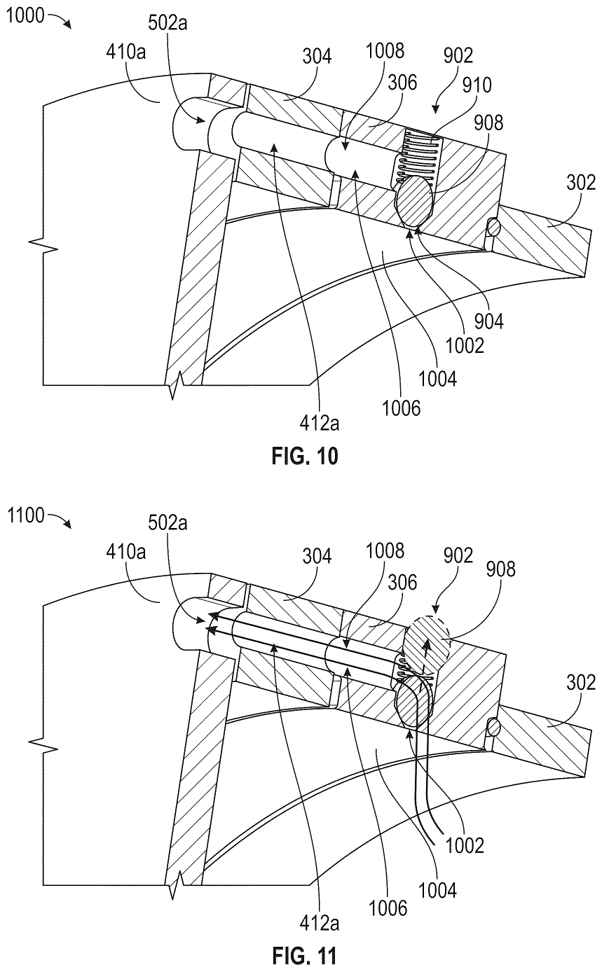

FIG. 10 is a view 1000 along an axial direction of a section of the housing for the embodiment of FIG. 9 in one configuration. The view 1000 shows the gear plate 302, back plate 304, housing 306 and the blade 410a. The check valve 902 in the housing 306 shows the channel 904 having a first opening 1002 at an inner surface 1004 of the housing. A second channel 1006 extends from the check valve 902 along the axis of the housing 306 to a second opening 1008 that is on an axial surface facing the back plate 304. The relief orifice 412a of the back plate 304 is aligned with the second channel 1006 of the housing 306. The blade 410a shows the escape hole 502a. The configuration of FIG. 10 includes the escape hole 502a being aligned with the relief orifice 412a and the second channel 1006 and with the check valve 902 closed. In this configuration. no fluid escapes from the interior.

FIG. 11 is a view 1100 along an axial direction of the section of the VSP 216 for the embodiment of FIG. 9 in another configuration. The configuration of FIG. 11 includes the escape hole 502 being aligned with the relief orifice 412a and the second channel 1006 and with the check valve 902 in an open position. In this configuration, the fluid within the interior of the VSP 216 can flow out of the interior through the channel 904, check valve 902, second channel 1006, relief orifice 412a and escape hole 502a.

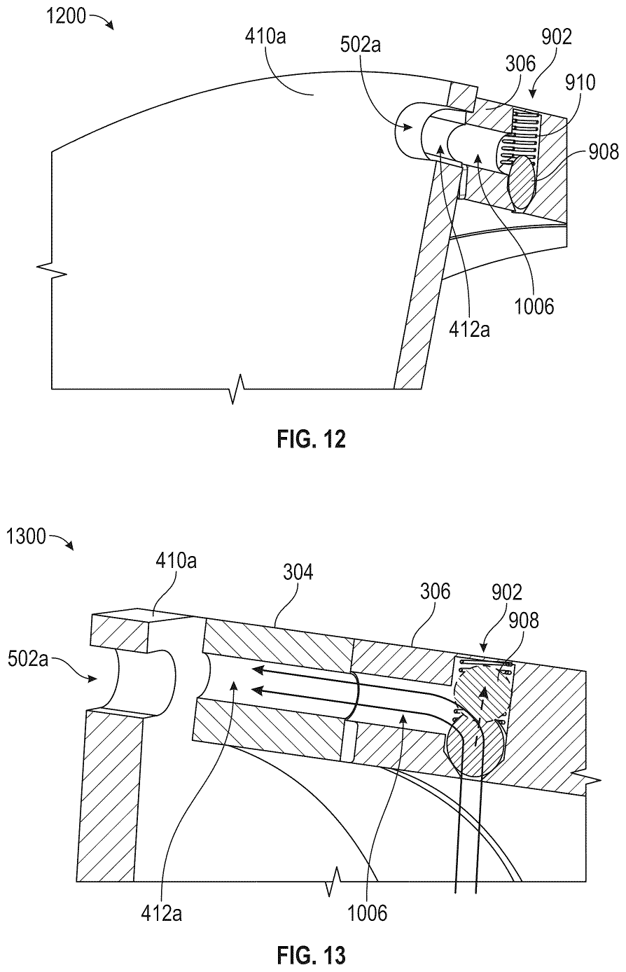

FIG. 12 is a view 1200 along the axial direction of the section of the VSP 216 for the embodiment of FIG. 9 in yet another configuration. The configuration of FIG. 12 includes the escape hole 502a not being aligned with the relief orifice 412a and the second channel 1006 and with the check valve 902 in a closed position. In this configuration, the fluid in the interior of the VSP 216 is unable to flow out of the interior.

FIG. 13 is a view 1300 along the axial direction of the section of the VSP 216 for the embodiment of FIG. 9 in yet another configuration. The configuration of FIG. 13 includes the escape hole 502 not being aligned with the relief orifice 412a and the second channel 1006 while the check valve 902 in an open position. In this configuration, the fluid in the interior of the VSP 216 is unable to flow out of the interior.

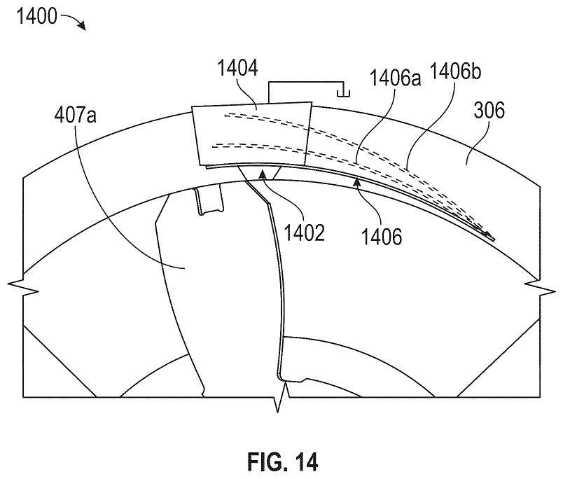

FIG. 14 is a view 1400 of the interior of the VSP 216 in another embodiment. The housing 306 includes a channel 1402 that extends radially into the housing 306. The channel 1402 connects to a wave spring type check-valve, also known as a lamella valve 1406, including a chamber 1404 that extends axially along the housing 306. The lamella valve 1406 is located between the passage and the chamber 1404 and acts as a gate to separates the passage 1402 from the chamber 1404. The lamella valve allows the fluid to flow into the chamber 1404 when a magnitude of a crack-open preload force is exceeded and prevents flow when the pressure is below the preload magnitude. As the pressure in the interior chamber reaches the critical pressure (a crack open pressure), the lamella valve opens a flow path to the housing chamber 1404 and allows pressure to be relieved (similar to relief provide by the flow of fluid in FIG. 11). The wave spring of the lamella valve 1406 deflects radially (as shown by spring positions 1406a and 1406b) to allow the channel 1402 to be open, as the pressure reaches or exceeds the critical pressure. FIG. 14 shows a representative embodiment including a wave spring that deflects radially. In other embodiments, the wave spring can be configured to deflect in an axial direction. The direction of deflection can be selected depending on available packaging space. The configurations shown in FIGS. 10-13 are applicable to pressure relief using the check valve 1403 of FIG. 14.

The Variable Shunt Phaser can be used in any power system that involves a rotary actuator at high-speed operation (such as greater than 6000 rpm or greater than 8,000 rpm). The system can be a hydraulic system that powers the Variable Shunt Phaser, or Variable Phaser in general.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A variable shunt phaser, comprising:
a shell configured to rotate with a rotor shaft of an electric motor of an electric vehicle, the shell including a housing, a gear plate, and a back plate coupled to form an enclosed space within the shell, wherein a rotation of the shell creates a pressure differential between an outer diameter of the shell and an inner diameter of the shell;
an inner rotor disposed within the enclosed space, the inner rotor configured to rotate with respect to the housing;
a relief orifice in the back plate at the outer diameter of the shell;
a blade coupled to an exterior section the inner rotor, wherein the blade is external to the shell and is rotatable with respect to the back plate; and
an escape hole in the blade, wherein rotation of the inner rotor with respect to the housing moves the escape hole into alignment with the relief orifice to open the relief orifice, thereby reducing the pressure differential within the enclosed space.

2. The variable shunt phaser of claim 1, wherein the relief orifice is located at the back plate and the escape hole is at a same radial location as the relief orifice.

3. The variable shunt phaser of claim 1, wherein the blade includes a first seal at a first circumferential side of the escape hole and a second seal at a second circumferential side of the escape hole.

4. The variable shunt phaser of claim 1, further comprising a channel that extends radially through the housing and the inner rotor includes a vane that rotates within the shell.

5. The variable shunt phaser of claim 4, further comprising a seat and a ball within the channel, the ball biased radially inward against the seat by a spring, wherein the ball moves away from the seat when a pressure within the enclosed space reaches a critical pressure defined by the spring.

6. The variable shunt phaser of claim 4, further comprising a lamella valve configured to slide radially along the housing and is biased to a position over the channel, wherein the lamella valve moves radially along the housing when a pressure within the enclosed space reaches a critical pressure.

7. The variable shunt phaser of claim 1, wherein a range of angular rotation for the inner rotor is defined by a circumferential width of an interior chamber in the enclosed space.

8. A motor for an electric vehicle, comprising:
a rotor shaft; and
a variable shunt phaser rotatable with the rotor shaft, the variable shunt phaser comprising:
a shell configured to rotate with the rotor shaft, the shell including a housing, a gear plate a back plate coupled to form an enclosed space within the shell, wherein rotation of the shell creates a pressure differential between an outer diameter of the shell and an inner diameter of the shell;
an inner rotor disposed within the enclosed space, the inner rotor configured to rotate with respect to the housing;
a relief orifice in the back plate at the outer diameter of the shell;
a blade coupled to an exterior section of the inner rotor, wherein the blade is external to the shell and is rotatable with respect to the back plate; and
an escape hole in the blade, wherein rotation of the inner rotor with respect to the housing moves the escape hole into alignment with the relief orifice to open the relief orifice, thereby reducing the pressure differential within the enclosed space.

9. The motor of claim 8, wherein the relief orifice is located at the back plate and the escape hole is at a same radial location as the relief orifice.

10. The motor of claim 8, wherein the blade includes a first seal at a first circumferential side of the escape hole and a second seal at a second circumferential side of the escape hole.

11. The motor of claim 8, further comprising a channel that extends radially through the housing and the inner rotor includes a vane that rotates within the shell.

12. The motor of claim 11, further comprising a seat and a ball within the channel, the ball biased radially inward against the seat by a spring, wherein the ball moves away from the seat when a pressure within the enclosed space reaches a critical pressure defined by the spring.

13. The motor of claim 11, further comprising a lamella valve configured to slide radially along the housing and is biased to a position over the channel, wherein the lamella valve moves radially along the housing when a pressure within the enclosed space reaches a critical pressure.

14. The motor of claim 8, wherein a range of angular rotation for the inner rotor is defined by a circumferential width of an interior chamber in the enclosed space.

15. A power system, comprising:
a stator;
a rotor; and
a variable shunt phaser rotatable with the rotor to control a timing between the stator and the rotor, the variable shunt phaser comprising:
a shell configured to rotate with the rotor, the shell including a housing, a gear plate a back plate coupled to form an enclosed space within the shell, wherein rotation of the shell creates a pressure differential between an outer diameter of the shell and an inner diameter of the shell;
an inner rotor disposed within the enclosed space, the inner rotor configured to rotate with respect to the housing;
a relief orifice in the back plate at the outer diameter of the shell;
a blade coupled to an exterior section the inner rotor, wherein the blade is external to the shell and is rotatable with respect to the back plate; and
an escape hole in the blade, wherein rotation of the inner rotor with respect to the housing moves the escape hole into alignment with the relief orifice to open the relief orifice, thereby reducing the pressure differential within the enclosed space.

16. The power system of claim 15, wherein the relief orifice is located at the back plate and the escape hole is at a same radial location as the relief orifice.

17. The power system of claim 15, wherein the blade includes a first seal at a first circumferential side of the escape hole and a second seal at a second circumferential side of the escape hole.

18. The power system of claim 15, further comprising a channel that extends radially through the housing and the inner rotor includes a vane that rotates within the shell.

19. The power system of claim 18, further comprising a seat and a ball within the channel, the ball biased radially inward against the seat by a spring, wherein the ball moves away from the seat when a pressure within the enclosed space reaches a critical pressure defined by the spring.

20. The power system of claim 18, further comprising a lamella valve configured to slide radially along the housing and is biased to a position over the channel, wherein the lamella valve moves radially along the housing when a pressure within the enclosed space reaches a critical pressure.
